(19) United States
(12) Patent Application Publication
(10) Pub. No.: US 2011/0313903 A1
(43) Pub. Date: Dec. 22, 2011

(54) METHOD AND SYSTEM FACILITATING AN END-TO-END SOLUTION FOR ONE OR MORE SERVICE OFFERINGS

(75) Inventors: Gnanapriya C., Bangalore (IN); Arup Goswami, Bangalore (IN); Nishi Mathur, Bangalore (IN); Munish Kashyap, Pune (IN); Jamsheed Kormath, Manjeri (IN); Rohit Prasad, Bangalore (IN); Yuvraj Sakharam Magdum, Pune (IN); Sreekumar Gopalakrishnan, Perunna West Changanassery (IN); Anand Subramanian, Madhura Nagar Hyderabad (IN); Soumen Saha, Kolkata (IN)

(73) Assignee: INFOSYS TECHNOLOGIES LIMITED, Bangalore (IN)

(21) Appl. No.: 12/855,026

(22) Filed: Aug. 12, 2010

(30) Foreign Application Priority Data
Jun. 18, 2010 (IN) 1696/CHE/2010

(51) Int. Cl. G06Q 10/00; G06Q 30/00

(52) U.S. Cl. 705/34; 705/1.1

(57) ABSTRACT

A system and method facilitating an end-to-end solution for one or more service offerings. The end-to-end solution includes the modeling, provisioning, and rating of a single subscription as at least one of prepaid and postpaid. The system includes a CRM layer, an integration layer, a rating and billing management layer, and a service activation platform layer.

### FIELD OF THE INVENTION

The present invention relates, in general, to the telecommunication field, where different service solutions or platforms are integrated. More specifically, the invention relates to a method and system facilitating an end-to-end solution for offering one or more services.

### BACKGROUND

The telecommunication industry is one of the fastest growing industries in the world, and thus, it has gained popularity over the past few years. The major reasons for the growth of this industry are, for example, the use of modern/advanced technologies, the inclusion of new services, and market competition.

The introduction of new solutions and services has in turn enabled telecom operators/service providers to improve the speed and quality of digital communication. However, on the hindsight, the prices for such services have reduced drastically because of the increase in competition. Further, because of the reduction in the prices of existing offerings, the telecom service providers are experiencing a downtrend in revenues or Average Revenue per User (ARPU). In general, service usage by each customer on a monthly basis acts as a source of steady revenue stream for the telecom service providers. Since the major source of revenue for these providers is based on the service usage by each customer, it becomes critical for them to identify profitable customers and to retain them by offering differentiated services. The service providers also need to reduce operational costs to be able to stand competition.

To retain the existing customers, to survive competition, and to retain/increase ARPU, the telecom service providers need to develop services/products that address specific needs of the customer. For instance, the telecom operators need to devise services that can provide better control to the customers over their spending. In addition, the operators need to devise services that enable the customers to easily separate and track their personal and official spending for a single subscription. Further, the operators need to devise differentiated services and offerings to get an edge over competition.

There exist a number of solutions in the market to address various needs of the customers. These solutions focus on providing service offerings to the customers, where such services are either prepaid or postpaid, corresponding to a single subscription.

In light of the foregoing discussion, there is a need to provide service offerings to the customer, where the customer has the flexibility to classify the services he/she wishes to subscribe to as prepaid or postpaid or both, corresponding to a single subscription. Accordingly, the service providers also have better control on the credits offered to the subscribers by movement from postpaid to prepaid or vice-versa, based on certain events.

Further, there is also a need for the telecom operators to be able to rate these services as prepaid or postpaid or both in the real time. Such rating mechanism should also avoid using multiple rating engines to rate the services. Accordingly, these service offerings can bring down the operational costs for the service providers.

### SUMMARY

The present invention describes a system facilitating an end-to-end solution for one or more service offerings, wherein the one or more service offerings include a hybrid service offering and a multi-wallet service offering. The end-to-end solution includes modeling, provisioning, rating, and billing of a single subscription as prepaid and postpaid. The end-to-end solution also includes realizing various customer care operations, which are received by multiple channels such as an Short Message Service (SMS), Short Code, Interactive Voice Response (IVR) and the like. The system includes a Customer Relationship Management (CRM) layer, an integration layer, a rating and billing management layer, and a service activation platform layer. The CRM layer is configured for maintaining one or more service plans for each of the service offerings. Each of these service plans includes service offers, wherein each of the service offers includes service bundles defining one or more services as at least one of the prepaid and the postpaid. Further, the integration layer is configured for provisioning an order placed by a customer, to subscribe to one of the one or more service offerings, into different layers of the system in the real time. The order is provisioned for creating an account of the customer in different layers of the system. Also, the service plan subscribed by the customer is firstly associated with the account of the customer, and then the service bundles associated with the account of the customer are provisioned into different layers of the system. The different layers of the system may include, for example, the rating and billing management layer and the service activation platform layer. Further, based on service usage, the rating and billing management layer authenticates and rates services as at least one of the prepaid and the postpaid in the real time. The rating and billing management layer is further configured for realizing one or more customer care functions as at least one of prepaid and postpaid in the real time. Moreover, the service activation platform layer is configured for activating the services corresponding to the one of the one or more service plans subscribed by the customer on a network.

The present invention further describes a Customer Relationship Management (CRM) system facilitating an end-to-end solution for one or more service offerings. These service offerings may include, for example, a hybrid service offering and a multi-wallet service offering. The CRM system is configured for maintaining one or more service plans for each of the service offerings. Each of these service plans includes service offers, wherein each of the service offers includes service bundles defining one or more services as at least one of the prepaid and the postpaid. Further, the CRM system is configured for maintaining a billing profile for each of the service offers.

Further, the present invention describes an integration system facilitating an end-to-end solution for one or more service offerings. The service offerings may include a hybrid service offering and a multi-wallet service offering. The integration system is further configured for receiving an order from a customer to subscribe to one of the service offerings. Each of the service offerings includes one or more service plans. Each of these service plans includes service offers, wherein each of the service offers includes service bundles defining one or more services as at least one of the prepaid and the postpaid. The integration system is further configured for updating information corresponding to the order into one or more systems, wherein the information is updated in the real time. Such systems may be, for example, a CRM system, a rating and billing management system, and a service activation platform system.

Furthermore, the present invention describes a rating and billing management system facilitating an end-to-end solution for one or more service offerings. The service offerings correspond to a hybrid service offering and a multi-wallet service offering. The rating and billing management system, as described, is configured for identifying a service offering type from an order placed by a customer, wherein the service offering type belongs to a hybrid service offering and a multi-wallet service offering. The rating and billing management system is further configured for authorizing services in the real time corresponding to one of the service offerings requested by the customer. Further, the rating and billing management system is configured for rating the services as at least one of prepaid and postpaid in the real time. In addition to this, the rating and billing management system is configured for realizing one or more customer care functions as at least one of prepaid and postpaid in the real time.

Additionally, the present invention describes a method for handling a single subscription as prepaid and postpaid for one or more service offerings. The one or more service offerings may include a hybrid service offering and a multi-wallet service offering. The method described above includes receiving an order from a customer to subscribe to one of the service offerings, wherein each of the service offerings includes one or more service plans. Further, each of these service plans includes service offers, wherein each of the service offers includes service bundles defining one or more services as at least one of the prepaid and the postpaid. The method further includes creating an account of the customer in one or more layers in the real time. Also, a service instance corresponding to the one of the service offerings subscribed to by the customer is associated with the account of the customer. Further, the method includes authorizing services requested by the customer in the real time. Moreover, the method includes rating the services as at least one of prepaid and postpaid in the real time. Additionally, the method includes realizing one or more customer care functions as at least one of prepaid and postpaid in the real time.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 illustrates an environment in which various embodiments of the invention may be practiced;

FIG. 2 is a flow diagram illustrating a method for handling a single subscription as prepaid and postpaid for one or more service offerings, in accordance with an embodiment of the invention;

FIG. 3 is a flow diagram illustrating a method for balance enquiry request received from a Mobile Directory Number (MDN), in accordance with an embodiment of the invention;

FIG. 4 is a flow diagram illustrating a method for top-up request received from a Mobile Directory Number (MDN), in accordance with an embodiment of the invention;

FIG. 5 is a flow diagram illustrating a method for balance transfer request received from a Mobile Directory Number (MDN), in accordance with an embodiment of the invention; and

FIG. 6 represents an array illustrating a structure of profile object stored in the repository, in accordance with an embodiment of the invention.

### DETAILED DESCRIPTION OF THE DRAWINGS

The present invention describes a system and method facilitating an end-to-end solution for one or more service offerings corresponding to a single subscription. The service offerings are, for example, a hybrid service offering and a multi-wallet service offering. The hybrid service offering corresponds to an offering, where one or more services, such as, but are not limited to, a voice call, a voice message, a Short Message Service (SMS), a Multimedia Messaging Service (MMS), data, Wimax, and various other value-added services, are defined as prepaid or postpaid or both depending on a pre-defined criteria. In other words, a hybrid service offering corresponds to an offering, where a single subscription or a single MDN is considered as prepaid and postpaid. For instance, an SMS can be defined as prepaid, whereas a voice call can be defined as postpaid. Further, the multi-wallet service offering corresponds to an offering, where the customer's account balance or threshold limit is managed at the service level. The multi-wallet service offering can be prepaid or postpaid or both. In case of prepaid, a voice call has a separate balance, for example, USD 50; an SMS has a separate balance, for example USD 15; and similarly, other such services have separate balances. In case of postpaid, a voice call may have a separate threshold limit, for example USD 300; an SMS may have a separate threshold limit, for example USD 100; and similarly, each of such services may have a separate threshold limit. By having such service offerings, the customer can easily switch from prepaid to postpaid or vice-versa, based on his/her specific needs. Also, these service offerings/solutions enable the customer to better control and track individual spending on each of the services.

Further, the end-to-end solution for the one or more service offerings can be implemented by using, but is not limited to, Oracle Operational Support System (OSS) and Business Support System (BSS) Stack. There can be various other types of stacks that can be used to implement the invention described herein.

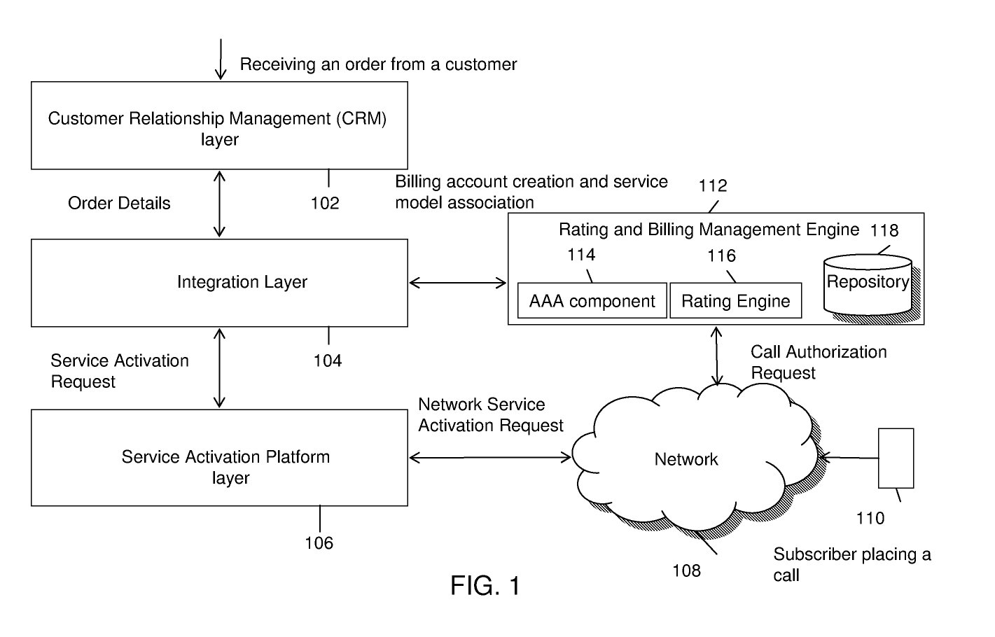

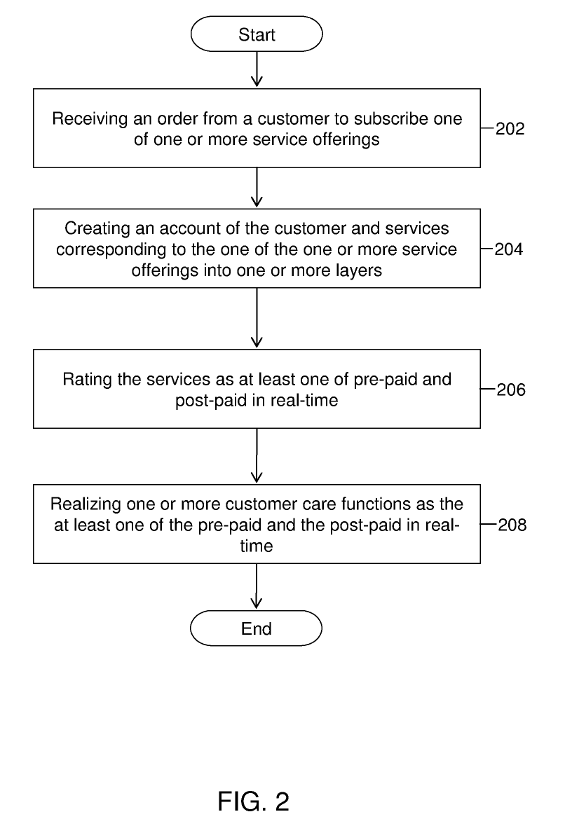

FIG. 1 illustrates an environment in which various embodiments of the invention may be practiced. To describe the system elements illustrated in FIG. 1, references will be made to FIGS. 2, 3, 4, and 5, although, it will be apparent to those skilled in the art that the steps executed by the system elements can be applicable to any other embodiment of the present invention.

FIG. 1 depicts a system facilitating an end-to-end solution for one or more service offerings. The system includes one or more layers shown as a Customer Relationship Management Layer (CRM) 102, an integration layer 104, a service activation platform layer 106, and a rating and billing management engine 112. Rating and billing management engine 112 can also be referred to as the rating and billing management layer. Rating and billing management engine 112 further includes an Authentication, Authorization and Accounting (AAA) component 114, a rating engine 116, and a repository 118 containing profile objects corresponding to each customer. The system further includes a telecom network 108 and a device 110.

As shown in FIG. 1, CRM layer 102 is configured to receive an order placed by the customer. The order corresponds to a request to subscribe to one of one or more service offerings, such as, a hybrid service offering or a multi-wallet service offering. Each of the service offerings includes one or more service plans. Further, each of these service plans includes service offers such as a prepaid bundle and a postpaid bundle. Each of the service offers further includes one or more service bundles defining one or more services as at least one of the prepaid and the postpaid.

Referring back to the step described above, after receiving the order from the customer, order details, such as, an MDN, the type of service offering, and a corresponding service plan that the customer wishes to subscribe to are captured. The order details are captured at CRM layer 102. Further, the type of service offerings and the corresponding service plans have been described in detail, in conjunction with FIG. 2. The service plans can also be referred to as product models.

After capturing the details from the order placed by the customer, the order details are passed onto integration layer 104. Integration layer 104 interacts with rating and billing management engine 112 so that an account of the customer is created in rating and billing management engine 112. Also, one of the one or more service offerings and a corresponding service plan, which the customer wishes to subscribe to, are associated with the account of the customer in rating and billing management engine 112. After creating the account and associating the service plan with the account of the customer, service instances are created for each of the service offers by rating and billing management engine 112. Each of the service instances defines a set of services to be considered as prepaid or postpaid or both. Further, for each of the service instances, a corresponding balance group is created by rating and billing management engine 112. Each of the balance groups defines balance associated with a corresponding service instance. Also, for each of the service offers or each of the bundles, a corresponding billing profile is created by rating and billing management engine 112. Each of the billing profiles defines an amount of bill corresponding to each of the service plans.

Further, a profile object is created for the customer, and it is stored in repository 118 present in rating and billing management engine 112. The profile object is an array containing details about the service offering subscribed by the customer. The details stored in the profile object may include, for example, but are not limited to, an MDN, the type of service offering, service instance, balance groups, and billing profiles and indicators. Once, the creation of the billing account and the association of the service plan are performed, integration layer 104 sends a message such as a “Service Activation Request” to service activation platform layer 106. The request is sent by integration layer 104 so that services corresponding to the service offering, which the customer wishes to subscribe to, are activated at service activation platform layer 106. Once the services have been activated at service activation platform layer 106, a “Network Service Activation Request” is sent by service activation platform layer 106. The request is sent by service activation platform layer 106 to network 108 so that the services are also activated on communication network 108.

Once the services have been activated on network 108, the customer can request for the one or more services by using device 110. For example, the customer can make calls to his/her contacts and send an SMS, MMS, and data to his/her contacts and the like by using device 110. Examples of device 110 as shown in FIG. 1 may include, but are not limited to, mobile phones, Personal Digital Assistants (PDAs), Blackberry®, and smartphones.

In the exemplary embodiment, it can be assumed that the customer sends a service request, for example, by placing a call or by sending an SMS; the service request is received by network 108. Network 108 routes the service request to rating and billing management engine 112 by sending a message “Call Authorization Request”. Rating and billing management engine 112 authorizes the service request, such as a voice call or an SMS received from the customer. After authorizing the service request, the service request is forwarded to AAA component 114. AAA component 114 identifies the type of service offering and the corresponding service plan subscribed to by the customer, wherein the type of service offering and the corresponding service plan are identified from the service request. In other words, AAA component 114 checks which service offering and corresponding service plan the customer has subscribed to.

After identifying the type of service offering and the corresponding service plan, a profile object of the customer stored in the repository is parsed by rating engine 116. The profile object corresponds to an array containing details of the service offering subscribed to by the customer as described above.

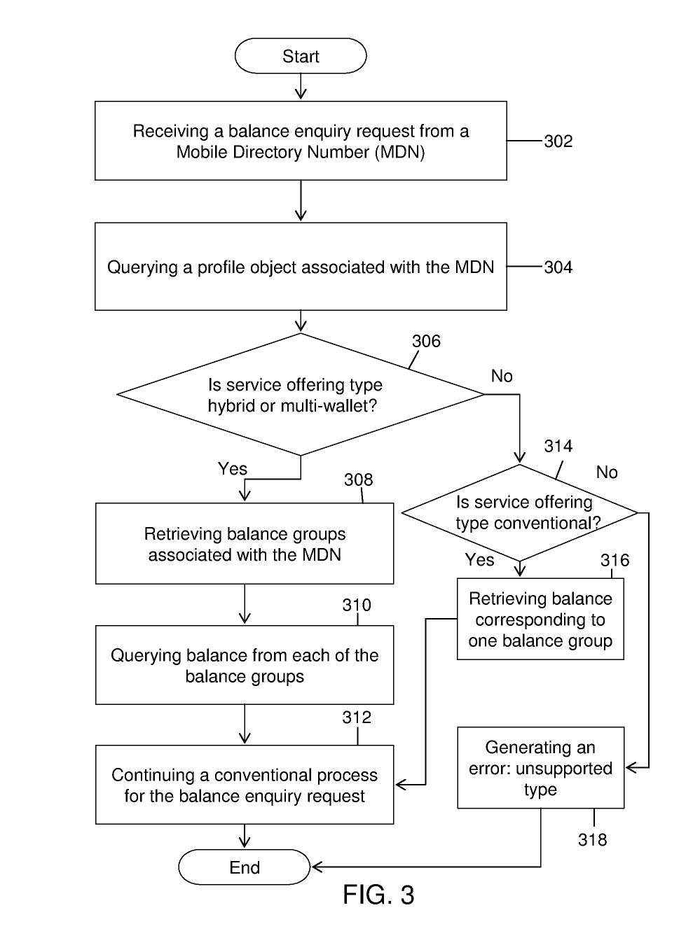

After performing the steps of identification for the type of service offering and the parsing of the profile object, rating engine 116 charges/rates the services requested by the customer as at least one of prepaid and postpaid, based on the information stored in the repository. The rating is performed in the real time. For instance, the rating of the services requested by the customer is performed based on the service offering and the corresponding service plan subscribed to by the customer. Further, rating engine 116 also realizes one or more customer care functions, for example, but are not limited to, balance enquiry request, the balance transfer request, and the top-up request, as at least one of prepaid and postpaid. The process for realizing the one or more customer care functions as at least one of prepaid and postpaid has been described in detail, in conjunction with FIGS. 3, 4, and 5.

In addition to the system elements mentioned above, the system also includes a Service Control Point layer (SCP), not shown in the figure. The SCP layer is configured for performing session management for the services requested by the customer.

In an embodiment of the invention, the invention can be understood in terms of the modeling, provisioning, and rating of a single subscription or a single MDN as prepaid and postpaid.

In an embodiment of the invention, the modeling of the single subscription as prepaid and postpaid is described. As mentioned above, there are various service offerings, such as, a hybrid service offering and a multi-wallet service offering. Each of these service offerings includes various service plans. Further, each of these service plans includes service offers such as prepaid bundle and a postpaid bundle. Each of the service offers further includes one or more service bundles defining one or more services as at least one of the prepaid and the postpaid. Further, each of the service plans is defined by the telecom operators based on various needs of the customer. Once, the service plans have been defined, these plans are maintained at CRM layer 102. Further, these plans can be redefined or changed whenever required. The service plans are defined based on one or more parameters, such as, but are not limited to, a time of the day, a day of the week, a short code, usage in a billing cycle, a service type, a Close User Group (CUG), the location of the customer, the preferences of the customer, the destination of one or more services, content type, and the type of services. Further, for each of the service offers, a corresponding billing profile is maintained at CRM layer 102. The billing profile defines whether a service plan is to be considered as prepaid or postpaid or both.

In another embodiment of the invention, the provisioning of a single subscription as prepaid and postpaid in the real time is described. As discussed above, the customer places an order to subscribe to one of the service offerings and a corresponding service plan. The customer order is received by CRM layer 102, and CRM layer 102 passes the order to integration layer 104. When the order from the customer is received, all details related to the order are updated in different layers of the system at the same time, and this process has been described in detail below. After receiving the customer order by integration layer 104, an account of the customer is created in rating and billing management layer 112. Also, a service plan corresponding to the one of the service offerings subscribed to by the customer is associated with the account of the customer in rating and billing management engine 112. Further, integration layer 104 interacts with service activation platform layer 106 in order to activate services corresponding to the service plan, at service activation platform layer 106. In this manner, integration layer 104 updates the information received from the customer in different layers of the system, such as rating and billing management engine 112 and service activation platform layer 106.

In yet another embodiment of the present invention, the rating of a single subscription as prepaid and postpaid in the real time is described. After subscribing to one of the service offerings, the customer can send a service request to use one or more services. When the customer sends the service request by means, such as placing a call, the call can be rated as prepaid, or postpaid or both, based on the service plan subscribed by the customer. The rating is performed in the real time. The rating of the single subscription as prepaid and postpaid is managed by rating and billing management engine 112. Further, rating and billing management engine 112 realizes one or more customer care functions as at least one of prepaid and postpaid.

Various examples of the network shown in the figure may include, but are not limited to, a wireless communication network, a mobile network, such as, but are not limited to, Global System for Mobile Communication (GSM) network, the Code Division Multiple Access (CDMA) network, Wi-Fi, Wi-MAX and the like.

Those ordinarily skilled in the art can appreciate that the service offerings and the corresponding service plans mentioned above are exemplary in nature and that these are used to facilitate the description of the invention. When service offers are defined corresponding to each of the one or more service plans, a number of possible combinations of the one or more parameters are performed to define the service offers. There are various other types of service offers based on which the services are defined as at least one of prepaid and postpaid.

FIG. 2 is a flow diagram illustrating a method for handling a single subscription as prepaid and postpaid for one or more service offerings, in accordance with an embodiment of the invention. To describe the method illustrated in FIG. 2, references will be made to FIGS. 1, 3, 4, and 5, although, it will be apparent to those skilled in the art that the method can be applicable to any other embodiment of the present invention.

At step 202, an order from the customer to subscribe to one of one or more service offerings is received. The order can be placed by the customer through one or more channels. For example, the customer can place the order by using the Internet, by sending an SMS, by contacting customer care, or through Unstructured Supplementary Service Data (USSD) or through IVR. Various communication channels can be utilized by the customer to activate the services.

The one or more service offerings are, for example, a hybrid service offering and a multi-wallet service offering. These service offerings have been described in detail, in conjunction with FIG. 1.

In an exemplary embodiment of the invention, one of the service offerings corresponds to a hybrid service offering. The hybrid service offering includes one or more service plans. Examples of the one or more service plans can include, but are not limited to, a service-based switch from prepaid to postpaid and vice-versa, a time/short code-based switch from prepaid to postpaid and vice-versa, a Close User Group-(CUG-) based switch from prepaid to postpaid and vice-versa, and a usage-based shift from postpaid to prepaid and vice-versa.

The service-based switch from prepaid to postpaid plan has been described in accordance with an embodiment of the invention. According to this service plan, services are considered as either prepaid or postpaid, based on the corresponding type of the service. For instance, if a voice call is defined as prepaid, then the voice call is rated as prepaid. Similarly, if the SMS is defined as postpaid, then the SMS is rated as postpaid. Further, the service plans include service offers, such as, a prepaid bundle and a postpaid bundle. The prepaid bundle includes one or more service bundles defining a set of services as prepaid. Similarly, the postpaid bundle includes one or more service bundles defining a set of services as postpaid. For example, the postpaid bundle may include service bundles, such as voice and SMS. Further, each of the service bundles may include one or more services. For instance, voice, being one of the service bundles, includes one or more services, such as basic voice, call forward, CLIP, and the like. On the same lines, the prepaid bundle can also be defined.

In another embodiment of the invention, the time/short code-based switch from prepaid to postpaid plan has been described. According to this service plan, services are considered as prepaid or postpaid or both, depending on the time of the day. Further, the service plan contains service offers, such as a day bundle and a night bundle. The day bundle defines a set of services, such as a voice call and an SMS as postpaid, during the day time, for example, between 8:00 AM and 7:00 PM. The night bundle may define the same set of services, such as a voice call and an SMS as prepaid during the night time, for example, between 7:00 PM and 8:00 AM.

Similarly, the short-code based switch from prepaid to postpaid plan is described in accordance with an embodiment of the invention. According to this service plan, a short code is assigned to the customer for each prepaid and postpaid. Based on the short code sent by the customer, the services are considered as either prepaid or postpaid. For example, if the customer sends the short code such as “xxxx”, which is assigned as a code for prepaid, then the services are considered to be prepaid. Similarly, when the customer sends a short-code, such as “yyyy”, which is assigned as a short code for postpaid, then, the services are considered to be postpaid. Therefore, based on the short code assigned, services selected from the one or more services can be considered as prepaid or postpaid.

In another embodiment of the invention, a CUG-based switch from prepaid to postpaid plan has been described. According to this service plan, the services are considered as either prepaid or postpaid, based on a contact belonging to the CUG. A CUG is a list containing one or more contacts, such as friends, relatives, associates of the customer, and the like. Further, the service plan contains one or more service offers, such as a prepaid bundle and a postpaid bundle. The prepaid bundle defines a set of services, such as a voice call and an SMS as prepaid when the customer makes a call or sends an SMS to a contact, which does not belong to the CUG contact. However, the postpaid bundle may define a set of services, such as an SMS, a voice call, or an MMS, as postpaid when the customer sends the SMS or makes a call to a contact belonging to the CUG contact.

In yet another embodiment of the invention, the usage-based shift from postpaid to prepaid plan has been described. According to the service plan, services are considered as either prepaid or postpaid based on the usage of services by the customer. Further, the service plan contains one or more service offers, such as a prepaid bundle and a postpaid bundle. The postpaid bundle defines a set of services, such as a voice call or an SMS, as postpaid when the set of services used by the customer crosses the predefined threshold limit, for example, USD 60. However, the prepaid bundle defines a set of services, such as an MMS or location tracking/location-based service using GPS, as prepaid when the set of services used by the customer does not cross the predefined threshold limit, maybe USD 50.

Continuing with the description mentioned above, in another exemplary embodiment of the present invention, one of the one or more service offerings can be a multi-wallet service offering. The multi-wallet service offering can be either prepaid or postpaid. Further, the multi-wallet service offering includes one or more service plans. Each of the service plans further includes one or more service offers, such as, a prepaid bundle or a postpaid bundle. Each of the service bundles can have its own balance groups and balances or wallets that can be maintained at the level of service bundles. For example, a voice call has a separate balance, maybe USD 30; an SMS service has a separate balance, maybe USD 15, and the like. The subscriber is allowed to make voice calls equivalent to 30 USD only and not more unless he/she recharges the respective voice wallet.

Those ordinarily skilled in the art can appreciate that the service offerings and the corresponding service plans mentioned above are exemplary in nature and that these are used to facilitate the description of the invention. When service offers are defined corresponding to each of the one or more service plans, a number of possible combinations may be performed to define the service offers. There are various other types of service offers, based on which the one or more services are defined as at least one of prepaid and postpaid.

Continuing with the method steps as described in FIG. 2, the order as placed by the customer is received by CRM layer 102. After receiving the order, details of the order are captured at the CRM layer. Once the order details of the customer are captured, an account of the customer is created in one or more layers at step 204. At the same time, services corresponding to the one of the service offerings are created in one or more layers. In other words, a service plan corresponding to one of the service offerings subscribed by the customer is associated with the account of the customer. The layers, as described, correspond to rating and billing management engine 112 and service activation platform layer 106.

When the association of the service plan with the account of the customer is performed, service instances corresponding to each service bundles are created in the rating and billing management engine. Further, in the case of the multi-wallet offering, for each of the service bundles, a corresponding balance group is created, and thereafter, each balance group is associated with the corresponding service bundles. In other words, the postpaid bundle and prepaid bundle have separate balance groups. Also, a billing profile for each of the service bundles is created, and it is further associated with each of the corresponding balance group.

In an exemplary embodiment of the present invention, it can be assumed that the customer subscribed to a hybrid service offering and one of the service plans, such as a service-based switch from prepaid to postpaid. A service-based switch from prepaid to postpaid plan contains a prepaid bundle and a postpaid bundle. For the prepaid bundle, a service instance 1 is created and, for the postpaid bundle, a service instance 2 is created. The service instance 1 defines services to be considered as prepaid, and the service instance 2 defines services to be considered as postpaid. Further, for the service instance 1, a balance group 1 is created, and it is associated with the service instance 1. Similarly, for the service instance 2, a balance group 2 is created, and it is associated with the service instance 2. The balance group 1 defines balance for services considered as prepaid, whereas the balance group 2 defines a threshold limit for services treated as postpaid. Thereafter, a billing profile 1 is created corresponding to the prepaid bundle, and it is associated with the balance group 1. Similarly, a billing profile 2 is created corresponding to the postpaid bundle, and it is associated with the balance group 2. The billing profile 1 defines bill for the services treated as prepaid, and the billing profile 2 defines bill for the services considered as postpaid.

For one ordinary skilled in the art, it is understood that a similar process is followed for other service plans of the hybrid service offering, such as the time/short code-based switch from prepaid to postpaid, the CUG-based switch from prepaid to postpaid, and the usage-based switch from postpaid to prepaid.

In another exemplary embodiment of the present invention, it can be assumed that the customer is subscribed to a multi-wallet service offering and one of the service plans. The service plans may be prepaid or postpaid. For the prepaid plan, each of the services has a separate balance; and for each of the services, a corresponding service instance is created. For example, for a voice call, a service instance 1 is created; for an SMS, a service instance 2 is created; for an MMS, a service instance 3 is created; for Internet browsing, a service instance 4 is created, and the like. Further, a balance group for each of the service instances is created, and it is further associated with each of the service instances. For instance, for the service instance 1, a balance group 1 is created, and for the service instance 2, a balance group 2 is created. Further, the service instance 1 is associated with the balance group 1, and the service instance 2 is associated with the balance group 2. Thereafter, a billing profile for each of the service instances is created. For example, a billing profile 1 is created for the service instance 1, and a billing profile 2 is created for the service instance 2. Similarly, for the postpaid plan, where each of the services has a separate threshold limit, for each of the services, a corresponding service instance is created. Further, for each of the service instances, a corresponding balance group is created, and it is further associated with each of the service instances. Finally, a billing profile for each of the prepaid or postpaid bundle is created, and it is then associated with the corresponding balance groups.

Continuing with the method steps as described in the FIG. 2, after creating or establishing the account at the rating and billing management layer, the customer can request for the one or more services. For instance, the customer can place a call, send an SMS, and the like. Considering a case when the customer sends a service request by placing a call to one of his/her contacts, the call is routed through the network to the AAA component in the rating and billing management layer for authorization. The AAA component is responsible for authentication, authorization, and accounting in the real time. It holds a fast access memory caching the customer and subscription details.

The AAA component checks the type of service, for example, whether the service is a hybrid service or a multi-wallet service. After identifying the type of the service, the service request is routed to the rating engine by the AAA component. The rating engine rates or charges the services requested by the customer as at least one of prepaid and postpaid, at step 206. The rating is performed in the real time. The rating engine rates the services based on the service plan subscribed to by the customer.

In an exemplary embodiment of the present invention, where the customer has subscribed to the hybrid service offering and the service-based switch from prepaid to postpaid plan, a process of rating the services in the real time has been described. As described above, the plan contains a prepaid bundle and postpaid bundle. For the prepaid bundle, the service instance 1, the balance group 1, and the billing profile 1 are created, and are stored in the rating and billing management layer. For the postpaid bundle, the service instance 2, the balance group 2, and the billing profile 2 are created, and they are stored in the rating and billing management layer. In a case where the customer places a call to one of his/her contacts, the rating engine checks the profile object and recognizes that the service instance 1 defines the call is a prepaid service, and therefore, the balance group 1 is affected. This check happens in the real time. Accordingly, the billing profile is affected. For instance, as the call constitutes a part of the prepaid service, an amount is deducted from the prepaid account balance of the customer, and no bill is generated. Further, in another case, where the customer sends an MMS to his/her contact, the rating engine recognizes that the service instance 2 defines that the MMS sent is a postpaid service; therefore, the balance group 2 is affected. Accordingly, the billing profile 2 is affected. For example, as the MMS constitutes a part of the postpaid service, the amount spent to send the MMS is added to the bill of the customer.

For one ordinary skilled in the art, it is understood that the steps described above are applicable to rate the services corresponding to any plan of the hybrid service offering.

In another exemplary embodiment of the invention, one of the service offerings subscribed by the customer is a multi-wallet service offering. The multi-wallet service plans are either prepaid or postpaid, and they have been described above in detail. Here, it can be assumed that the customer is subscribed to a prepaid plan. According to this plan, each of the services has a separate balance. It is assumed that the customer sends an SMS to his/her contacts and that he/she places a call to one of his/her contacts, and the balance group 1 and the balance group 2 are affected, respectively, in these cases. As per the prepaid plan, the amount for sending the SMS is deducted from the balance available for the SMS, and similarly, the amount for placing the call is deducted from the balance available for placing the call.

In a similar manner, the steps can be followed for the postpaid bundle, where each of the service has a different threshold limit.

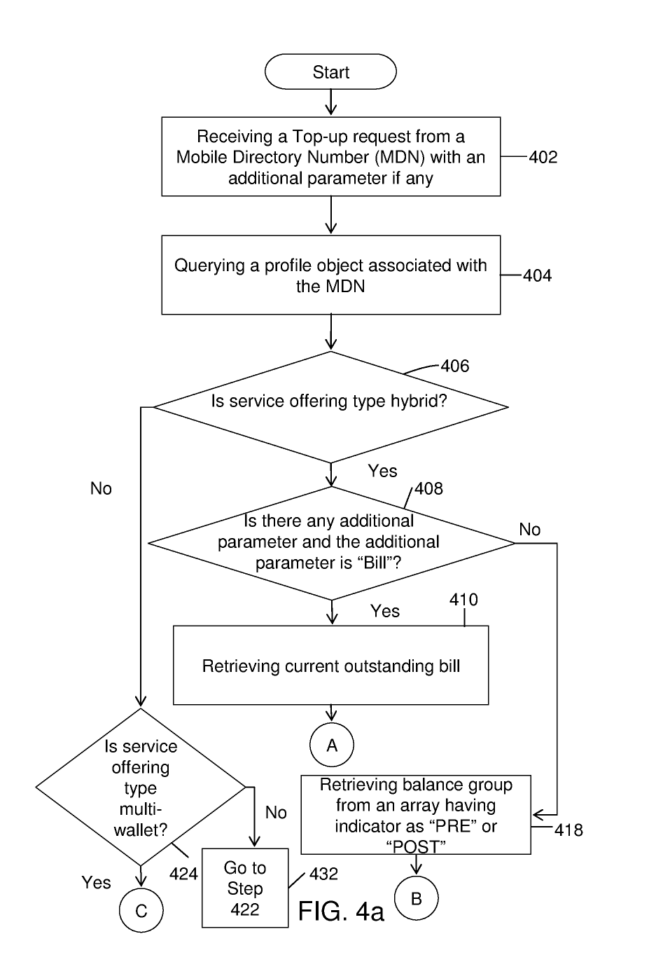

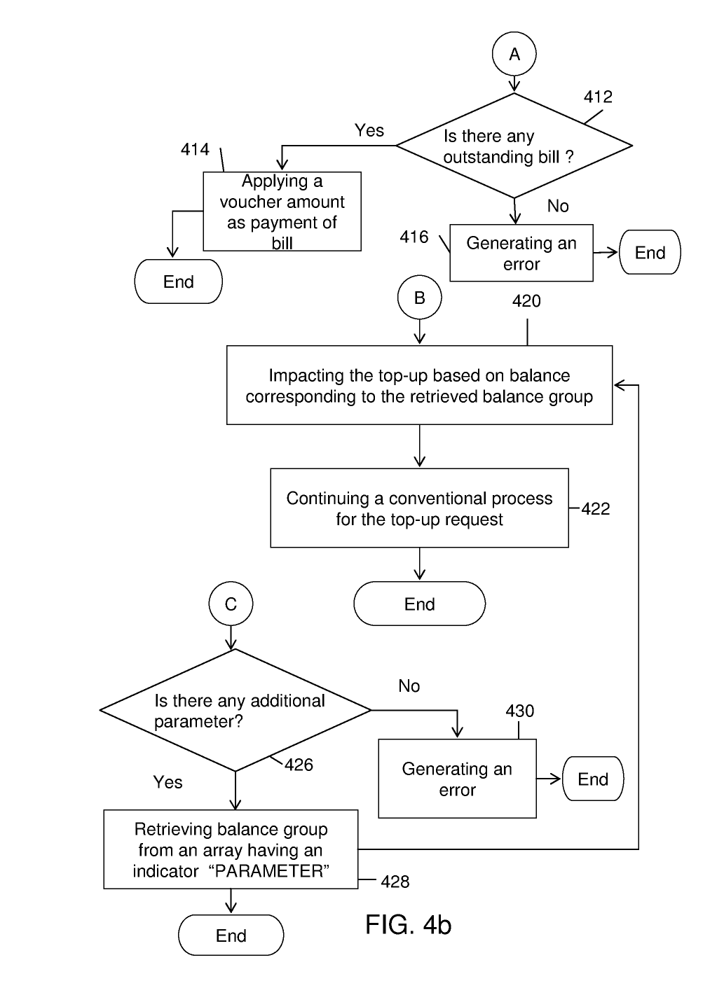

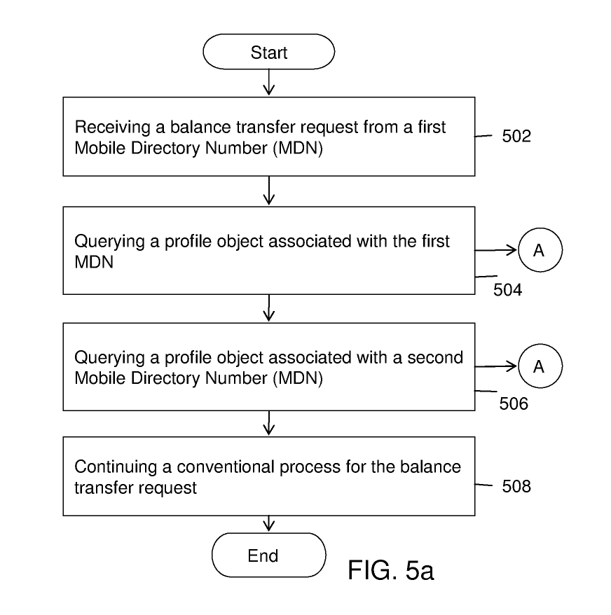

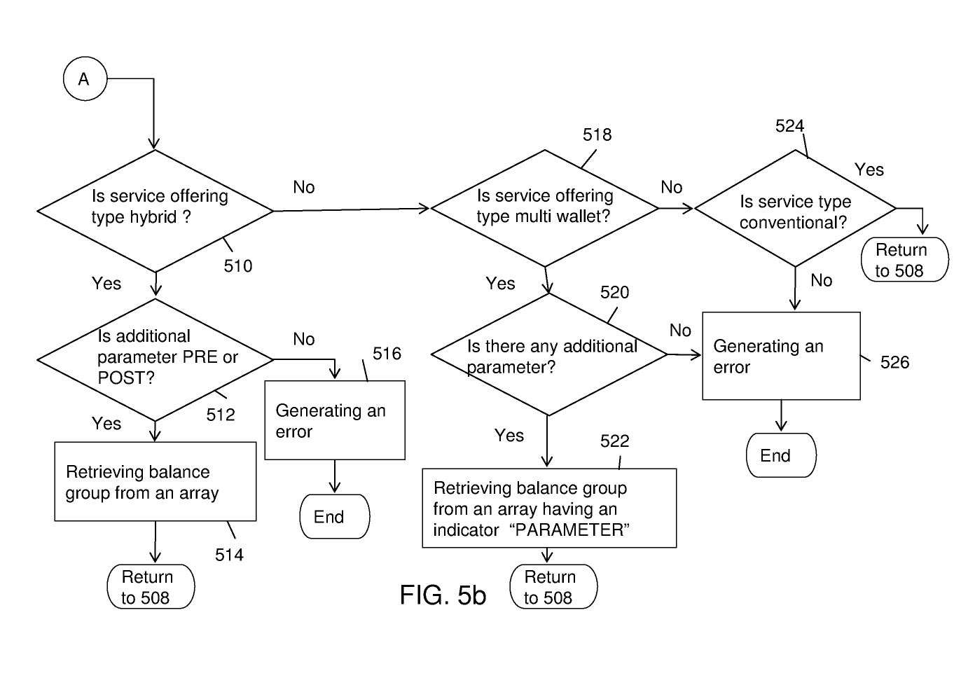

Continuing with the method steps as described above, at step 208, one or more customer care functions are realized as at least one of the prepaid and postpaid in the real time. The one or more customer care functions can include, but are not limited to, balance enquiry, balance transfer, top-up, or recharge. The realization of the customer care functions as prepaid and postpaid has been described in detail, in conjunction with FIG. 3, FIGS. 4, and 5.

In an exemplary embodiment of the invention, it can be assumed that the customer has subscribed to a hybrid service offering and the service-based switch from prepaid to postpaid. The customer places a call to one of his/her contacts. Further, the call placed by the customer is routed to the AAA component present in the rating and billing management engine through the network. Thereafter, the rating and billing management engine authorizes the call placed by the customer. The AAA component identifies which service offering is subscribed to by the customer. In other words, the AAA component identifies the type of service, for example, in this case, the AAA component identifies that the service is a hybrid service or not. Once the identification has been established, the call is routed to the rating engine. The rating engine now parses the profile object stored in the repository to identify the corresponding MDN, the service instance, the balance group, and the billing profile to be affected. Based on the information stored in the repository, the rating engine recognizes that the call placed by the customer should be considered as prepaid. Accordingly, the service instance 1, the balance group 1 and the billing profile 1 are affected. Thereafter, the rating engine rates the call as prepaid, and it deducts the amount for the call from the prepaid account balance of the single subscription or the MDN. Similarly, when the customer sends the MMS to one of his/her contacts, the request is forwarded to the rating and billing management engine through the network. The rating engine parses the profile object stored in the repository to identify the corresponding MDN, the service instance, the balance group, and the billing profile to be affected. After parsing the profile object of the customer, the rating engine recognizes that the service instance 2 stored in the repository defines that the MMS should be treated as postpaid. Accordingly, the balance group 2 and the billing profile 2 are affected. The amount spent to send the MMS is then added to the bill of the customer. Further, a monthly bill can be generated for services falling under postpaid.

For one ordinary skilled in the art, it is understood that similar process steps are followed for each of one or more service plans of the hybrid service offering.

In another exemplary embodiment of the invention, it can be assumed that the customer is subscribed to a multi-wallet service offering and a prepaid plan. When the customer sends an SMS to one of his/her contacts, the SMS is routed to the rating and billing management engine through the network. Thereafter, the rating and billing management engine authorizes the SMS sent by the customer. After authorizing, the SMS is routed to the AAA component. The AAA component identifies which service offering is subscribed to by the customer. In other words, the AAA component identifies the type of service, for example, in this case, the AAA component identifies that the type of the service is a multi-wallet service. Once the identification is being performed, the call is routed to the rating engine. The rating engine now parses the profile object stored in the repository to identify the MDN, the service instance, the balance group, and the billing profile to be affected. Based on the information stored in the repository, the rating engine recognizes that the SMS sent by the customer should be considered as prepaid. Accordingly, the service instance 1, the balance group 1, and the billing profile 1 are affected. Thereafter, the rating engine rates the SMS as prepaid, and it deducts the amount for sending the SMS from the corresponding SMS prepaid balance. Similarly, when the customer sends the MMS to one of his/her contacts, the request is forwarded to the rating and billing management engine over the communication network. Thereafter, the same steps can be followed as described above.

For one ordinary skilled in the art, it is understood that the sequence of steps described in the flow chart above is exemplary in nature and that it is used to facilitate the description of the present figure. There may be other possible sequences of the steps that can be performed to implement the invention described in the figure. Accordingly, it is clear that that the invention is not limited to the embodiment described herein.

FIG. 3 is a flow diagram illustrating a method for balance enquiry request received from a Mobile Directory Number (MDN), in accordance with an embodiment of the invention. To describe the method illustrated in FIG. 3, references will be made to FIGS. 1, 2, and 6, although, it will be apparent to those skilled in the art that the method can be applicable to any other embodiments of the present invention.

At step 302, a balance enquiry request from an MDN is received. The request is received from the customer by the rating and billing management engine. The balance enquiry request is received from the customer when the customer wishes to check balance for his/her single subscription or single MDN.

After receiving the request, a profile object associated with the MDN is queried at step 304. The profile object associated with the MDN is maintained in the repository at the rating and billing management engine. Further, the profile object contains the information about the service offering subscribed to by the customer, such as the type of service offering, service instance for each of the service offers (i.e., prepaid and postpaid bundle), and the balance group corresponding to each of the service offers.

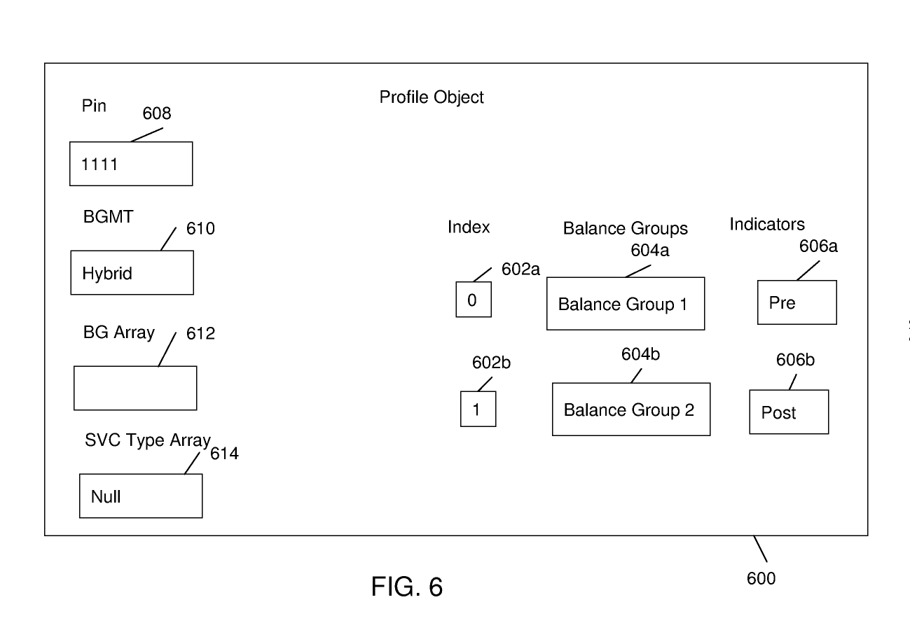

In an exemplary embodiment of the invention, the structure or format of the profile object as shown in FIG. 6 can be described herein. The profile object shown in the figure contains details of the subscription/offering subscribed to by the customer. As shown, the profile object contains index 602a and 602b, such as 0 and 1. The profile object further contains balance groups 604a and 604b, such as the balance group 1 and the balance group 2. Similarly, the profile object contains indicators 606a and 606b, such as Pre and Post. For example, the balance group 1 having an indicator “Pre” illustrates that the balance group 1 is affected for the prepaid services subscribed to by the customer corresponding to a single subscription. In a similar manner, the balance group 2 having an indicator “Post” illustrates that the balance group 2 is affected for the postpaid services subscribed to by the customer for a single subscription. Further, the profile object contains an array named “BGMT” 610, indicating the type of service offering subscribed to by the customer, such as hybrid service offering. In addition to this, the profile object contains a Pin 608, a BG array 612, and a SVC type array 614. Pin 608, as described here, corresponds to the personal pin of the customer that can be used for performing activities, such as balance transfer or bounce. BG array 612 contains an array of all balance groups associated with the subscription of the customer. SVC type array 614 contains values, such as true or false, to ascertain which service instances and balance groups are to be impacted while authorizing one or more service requests and accounting.

It will be appreciated by those of ordinary skill in the art that the format or structure of the profile object and the details contained in the profile object mentioned above are exemplary in nature and that they are used purely to facilitate the description of the present figure. There may be various other types of format or details associated with the profile object. Accordingly, it is clear that that the invention is not limited to the embodiment described herein.

Continuing with the process described above, at step 306, a condition is considered to check if the type of service offering subscribed to by the customer belongs to a hybrid service offering or to a multi-wallet service offering. If the service offering subscribed to by the customer is the hybrid service offering or the multi-wallet service offering, at step 308, all the balance groups associated with an MDN are retrieved. In an exemplary embodiment of the invention, it is understood that two balance groups are associated with the hybrid service offering, wherein one balance group corresponds to a balance group for the prepaid bundle, and the second balance group corresponds to a balance group for the postpaid bundle. Accordingly, for the hybrid service offering, two balance groups are retrieved.

In another exemplary embodiment of the invention, it is understood that balance groups associated with the multi-wallet service offering are equal to the number of services. For example, if there are three services, such as voice, an SMS, and data, accordingly, three distinct balance groups are retrieved.

Once the balance groups corresponding to the service offering have been retrieved, at step 310, a query is generated for each of the balance groups to retrieve the corresponding balance. Thereafter, at step 312, a conventional process for balance enquiry request is performed.

Referring to the condition check as described above, if the service offering type does not correspond to a hybrid service offering or to a multi-wallet service offering, at step 314, a check is performed to identify if the service offering type is conventional, such as truly prepaid or postpaid. If the check performed is successful, at step 316, a balance group corresponding to the conventional service is retrieved. Else, at step 318, an error of type “Unsupported Type” is generated.

Here, the process of the balance enquiry request has been described with the help of an example. In the exemplary embodiment of the invention, it can be considered that the customer is subscribed to either a hybrid service offering or to a multi-wallet service offering. The customer sends a balance enquiry request. The balance enquiry request sent from the MDN is received by the rating and billing management layer. After receiving the request, the rating and billing management layer retrieves the profile object associated with the MDN. The rating and billing management layer parses the profile object of the customer to retrieve the balance groups associated with the hybrid service offering or with the multi-wallet service offering. In the case of the hybrid service offering, two balance groups are retrieved: one for the prepaid bundle and another for the postpaid bundle. But, in the case of the multi-wallet service offering, the number of balance groups to be retrieved is equal to the number of services being used by the customer. Thus, if the customer uses three different services, such as, voice, SMS, and data, three different balance groups are retrieved.

Now, to evaluate the balance for the hybrid subscription, balance defined by each of the two balance groups is considered. For instance, balance shown by the balance group 1 may be USD 10, and balance shown by the balance group 2 may be USD 0. Further, to determine the total balance for the hybrid subscription, the balance corresponding to each of the balance groups is considered. Therefore, in this case, the total balance for the hybrid customer including the prepaid service and the postpaid service is USD 10.

Further, to evaluate the balance for the multi-wallet subscription, balance defined by each of the three balance groups is considered. For instance, balance shown by the balance group 1, the balance group 2, and the balance group 3 is USD 10, USD 20, and USD 30, respectively, for each of the services. To determine the total balance for the multi-wallet subscription, balance corresponding to each of the three balance groups is considered and, accordingly, the total balance of USD 60 is determined. In this case, the balance of USD 10, USD 20, and USD 30, are meant for voice, SMS, and data, respectively. Thereafter, a conventional process for the balance enquiry request is executed.

FIG. 4 is a flow diagram illustrating a method for top-up request received from a Mobile Directory Number (MDN), in accordance with an embodiment of the present invention. To describe the method illustrated in FIG. 4, references will be made to FIGS. 1 and 2, although, it will be apparent to those skilled in the art that the method can be applicable to any other embodiment of the present invention.

At step 402, a top-up request from an MDN is received. The request contains an additional parameter, if there is any. In general, the top-up request is received from the customer when the customer wishes to recharge his/her MDN with an amount of maybe, USD 10, USD 15, and the like. At step 404, the profile object associated with the MDN is queried. The profile object associated with the MDN is maintained in the repository at the rating and billing management engine. Further, the profile object contains the information about the service offering subscribed to by the customer, such as the type of service offering, service instance for each of the service offers (i.e., prepaid and postpaid bundle), and a balance group corresponding to each of the service offers. Thereafter, at step 406, a condition is checked to identify if the service offering type is hybrid or not. If the condition is “true”, at step 408, another check is performed to identify if there is any additional parameter and also if the additional parameter is “Bill”. If the condition is “yes”, at step 410, the current outstanding bill is retrieved. Thereafter, at step 412, a check is performed to identify if there is any outstanding bill. If the check performed is “true”, at step 414, a voucher amount is applied, as a payment of bill. Else, an error is generated at step 416.

If the condition at step 408 is not met, at step 418, the balance group from an array having indicator as “PRE” or “POST” is retrieved. Thereafter, at step 420, the process of top-up based on balance corresponding to retrieved balance group is performed. Thereafter, at step 422, a conventional process for the top-up request is executed.

If the check performed at step 406 is unsuccessful, at step 424, a condition is checked to identify if the service offering type is multi-wallet. If the service offering type is multi-wallet, at step 426, an additional check is performed to identify if there is any additional parameter. If the condition check is “yes”, at step 428, balance group from an array having indicator as “PARAMETER” is retrieved. Thereafter, steps 420 and 422 are performed. Further, if the condition check at step 426 is “false”, an error is generated at step 430.

At step 424, if the condition check is “false”, step 432 is performed, i.e., step 432 is re-routed to step 422, where a conventional process for the top-up request is followed.

An exemplary embodiment is described below to understand the concept of the top-up request.

The customer can be assumed to be subscribed to a hybrid service offering. The top-up or recharge request is received from the MDN for USD 150. The request is received by the rating and billing management layer. The rating and billing management layer retrieves the profile object associated with the MDN. Thereafter, a condition is checked to identify if there is any additional parameter and whether the additional parameter is “Bill”. If the condition is true, the current outstanding bill is retrieved. If the value of the current outstanding amount is found to be greater than zero, a voucher amount is applied as the payment of the bill. For example, if the outstanding bill is USD 100, USD 100 is considered as the payment of the bill, and the remaining amount of USD 50 is credited to the MDN. In case there is no outstanding bill, an error is generated.

Continuing with the condition check performed above, if there is no additional parameter, an error is returned.

In another exemplary embodiment, the customer can be assumed to have subscribed to a multi-wallet service offering. A request sent by the customer to recharge his/her MDN for USD 150 is received by the rating and billing management layer. The rating and billing management layer checks a condition to identify if there is any additional parameter. The additional parameter may include a voice call, an SMS, and MMS, and the like. If the condition is true, the balance group from an array having indicator as “PARAMETER” is retrieved. Thereafter, top-up based on the balance corresponding to retrieved balance group is affected. If, for example, the additional parameter is “SMS”, the corresponding balance group with parameter defined as “SMS” is retrieved. If the balance indicated by the “SMS” balance group is USD 10, USD 150 top-up is made for the SMS. The amount can only be used for the SMS service. Hence, the total balance for the SMS is now USD 160.

In case, the balance shown by the balance group is USD −10, the top-up is impacted after deducting USD 10 from the recharge amount of USD 150. Accordingly, the top-up of USD 140 is updated.

FIG. 5 is a flow diagram illustrating a method for balance transfer request received from a Mobile Directory Number (MDN), in accordance with an embodiment of the invention. To describe the method illustrated in FIG. 5, references will be made to FIGS. 1 and 2, although, it will be apparent to those skilled in the art that the method can be applicable to any other embodiment of the present invention.

At step 502, a balance transfer request from a first MDN is received. The first MDN corresponds to the MDN from which the balance is transferred. The balance transfer request is received from the customer when the customer wishes to transfer his/her phone balance to one of his/her contact's phone balance. Thereafter, at step 504, the profile object associated with the first MDN is queried. The profile object associated with the MDN is maintained in the repository at the rating and billing management engine. Further, the profile object contains the information about the service offering subscribed to by the customer, such as the type of service offering, service instance for each of the service offers (i.e., prepaid and postpaid bundle), and a balance group corresponding to each of the service offers. At step 510, a condition is checked to identify if the service offering type is hybrid. If the condition turns out to be “true”, at step 512, another check is performed to identify if there is an additional parameter “PRE” or “POST”. If the condition results out to be “yes”, a balance group from an array is retrieved at step 514. Thereafter, at step 508, a conventional process for the balance transfer request is performed. Further, if the condition at step 512 is “false”, an error is generated at step 516.

If the condition is found to be “false” at step 510, at step 518, a condition is checked to determine if the service offering type is multi-wallet. If the condition check is “true”, at step 520, another check is performed to identify if there is any additional parameter. If the condition check is “true”, at step 522, the balance group from an array having an indicator “PARAMETER” is retrieved. Thereafter, the process is returned to step 508, where a conventional process for the balance transfer is performed.

If the condition at step 520 is “false”, at step 526, an error is generated. If the condition check at step 518 is “false”, at step 524, a check is performed to identify if a service type is conventional, such as truly prepaid or truly postpaid. If the condition is “true”, step 508 is performed. Else, an error is generated at step 526.

At step 506, the profile object associated with the second MDN is queried. The second MDN corresponds to the MDN to which the balance is transferred. Once the querying of the profile object is performed, similar condition checks are executed, as described above for the first MDN. Thereafter, a conventional process for the balance transfer request is executed at step 508.

The conventional process for the balance transfer is known in the art, and thus, reference to the process is made herein. Further, the conventional process for the balance transfer corresponds to a process implemented for truly prepaid or postpaid services.

An exemplary embodiment is described below to understand the concept of balance transfer from the first MDN to the second MDN.

In the exemplary embodiment, the customer can be assumed to have subscribed to a hybrid service offering. The customer may send a balance transfer request from his/her MDN to the MDN of one of his/her contacts. The request is received by the rating and billing management layer. The rating and billing management layer checks a condition to identify if there is an additional parameter, such as “PRE” or “POST”. If the condition is “yes”, the corresponding balance group from an array having an indicator as “PRE” or “POST” is retrieved. As an example, a balance of USD 50 may be indicated by the balance group. Further, if the condition is “false”, an error is generated.

Thereafter, all the steps as described above are performed for the MDN to which the balance is to be transferred. Thus, in this exemplary embodiment, the MDN is one of customer's contacts. The MDN can also be referred to as the second MDN. Further, it can be assumed that the customer having the second MDN is a hybrid customer, and the balance retrieved from the balance group corresponding to the second MDN is USD 0. Accordingly, a balance of USD 50 is transferred from the first MDN to the second MDN. Hence, the second MDN is credited with the amount of USD 50.

Similarly, in another case, the customer can be assumed to have subscribed to the multi-wallet service offering. A balance transfer request is received from the customer by the rating and billing management layer. The rating and billing management layer checks a condition to identify if there is any additional parameter. The additional parameter can include an SMS, voice call, MMS, and the like. If the condition is “true” and the additional parameter is any of the above, the balance group from an array having an indicator defined as “PARAMETER” is retrieved. The balance retrieved from the balance group, having parameter as SMS, may be USD 10. Thereafter, a conventional process is followed for the balance transfer request.

In a similar manner, the steps described above are performed for the second MDN to which the balance is to be transferred. The customer having the second MDN is also considered to be subscribed to a multi-wallet service offering, and the balance retrieved from the balance group having the parameter as SMS may be USD 12. Finally, a conventional process for the balance transfer request is followed. Accordingly, a balance of USD 10 for the SMS from the first MDN is transferred to the second MDN. Hence, the second MDN is credited with USD 10, which can only be used for the SMS service. Therefore, the total amount for the SMS corresponding to the second MDN is USD 22.

Those ordinarily skilled in the art can appreciate that the flowcharts and conditions described at various steps in the figures above (FIGS. 3, 4, and 5) are exemplary in nature and are used purely to facilitate the description of the invention. There can be various other types of conditions that can be defined as per business requirements. Accordingly, it is made clear that that the invention is not limited to the embodiments described in the flowcharts.

The method and system described above have numerous advantages. The present invention facilitates the provision of service offerings to customers that address their specific needs. The customers, while availing such service offerings, get better control on their spending. Further, the present invention facilitates the rating of one or more services for the single subscription as at least one of prepaid and postpaid in the real time by using a single rating engine. Additionally, the present invention facilitates the realization of customer care functions as at least one of prepaid and postpaid in the real time.

The system for facilitating an end-to-end solution for one or more service offerings, as described in the present invention or any of its components, may be embodied in the form of a computer system. Typical examples of a computer system include a general-purpose computer, a programmed microprocessor or processor, a micro-controller, a peripheral integrated circuit element, and other devices or arrangements of devices that are capable of implementing the steps that constitute the method of the present invention.

The computer system comprises a computer, an input device, a display unit, and the Internet. The computer further comprises a microprocessor or processor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enables the computer system to connect to databases and networks such as Local Area Network (LAN), Metropolitan Area Network (MAN), Wide Area Network (WAN), and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for facilitating end-to-end solution for one or more service offerings. The computer program product includes a computer usable medium comprising a computer readable program code for executing a set program instructions comprising a program code for searching one or more documents in the Local Area Network (LAN). The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing, or a request made by another processing machine.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

What is claimed is:

1. A system facilitating an end-to-end solution for one or more service offerings, the end-to-end solution comprising modeling, provisioning and rating of a single subscription as prepaid and postpaid, the system comprising:
a. a Customer Relationship Management (CRM) layer configured for maintaining one or more service plans for each of the one or more service offerings, each of the one or more service plans comprising service offers, each of the service offers comprising service bundles defining one or more services as at least one of the prepaid and the postpaid;
b. an integration layer configured for provisioning an order placed by a customer to subscribe one of the one or more service plans into different layers of the system, the order being provisioned for creating an account of the customer and services corresponding to the one of the service plans into the different layers of the system in real time;
c. a rating and billing management layer configured for:
i. rating the services as the at least one of the prepaid and the postpaid, the rating being performed in real time;
ii. realizing one or more customer care functions as the at least one of the prepaid and the postpaid in real time; and
d. a service activation platform layer, the service activation platform layer being configured for activating the services corresponding to the one of the service plans subscribed by the customer on a communication network.

2. The system according to claim 1, wherein the one or more service offerings comprises a hybrid service offering and a multi-wallet service offering.

3. The system according to claim 1, wherein the CRM layer is further configured for capturing the order placed by the customer.

4. The system according to claim 1, wherein the CRM layer is further configured for maintaining a billing profile for each of the service offers.

5. The system according to claim 1, wherein the integration layer is further configured for identifying a service offering type from the order placed by the customer, the service offering type belonging to one of the one or more service offerings.

6. The system according to claim 1, wherein the rating and billing management layer is further configured for maintaining a profile of the customer.

7. The system according to claim 1, wherein the rating and billing management layer is further configured for authorizing the services requested by the customer in real time.

8. The system according to claim 1, wherein the rating and billing management layer is further configured for:
a. creating a service instance corresponding to each of the service offers;
b. creating a balance group corresponding to each of the service instances; and
c. creating a billing profile corresponding to each of the service offers.

9. The system according to claim 1 further comprising a Service Control Point (SCP) layer, the SCP layer is configured for performing session management for the services requested by the customer.

10. A Customer Relationship Management (CRM) system facilitating an end-to-end solution for one or more service offerings, the CRM system configured for:
a. maintaining one or more service plans for each of the one or more service offerings, each of the one or more service plans comprising service offers, wherein each of the service offers comprising service bundles defining one or more services as at least one of prepaid and postpaid; and
b. maintaining a billing profile for each of the service offers.

11. The CRM system according to claim 10 is further configured for capturing an order placed by a customer.

12. The CRM system according to claim 11, wherein the order corresponds to a request to subscribe one of the one or more service offerings.

13. An integration system facilitating an end-to-end solution for one or more service offerings, the integration system configured for:
a. receiving an order to subscribe one of the one or more service offerings, each of the one or more service offerings comprising one or more service plans, each of the one or more service plans comprising service offers, wherein each of the service offers comprising service bundles defining one or more services as at least one of prepaid and postpaid; and
b. updating information corresponding to the order into one or more systems, the information being updated in real time.

14. The integration system according to claim 13, wherein the one or more systems comprise a Customer Relationship Management (CRM) system, a rating and billing system, and a service activation platform system.

15. A rating and billing management system facilitating an end-to-end solution for one or more service offerings, the rating and billing management system configured for:
a. identifying a service offering type from an order placed by a customer, the service offering type belonging to one of the one or more service offerings;
b. authorizing services corresponding to one of the one or more service offerings requested by the customer in real time;
c. rating the services as at least one of prepaid and postpaid in real time; and
d. realizing one or more customer care functions as the at least one of the prepaid and the postpaid.

16. The rating and billing management system according to claim 15, wherein the services are rated as the at least one of the prepaid and the postpaid based on one or more parameters.

17. The rating and billing management system according to claim 15 is further configured for maintaining a profile of the customer.

18. The rating and billing management system according to claim 15 is further configured for:
a. creating a service instance for each service offers corresponding to the one of the one or more service offerings subscribed by the customer;
b. creating a balance group corresponding to each of the service instances; and
c. creating a billing profile corresponding to each of the service offers.

19. A method for handling a single subscription as prepaid and postpaid for one or more service offerings, the method comprising:
a. receiving an order from a customer to subscribe one of the one or more service offerings, each of the one or more service offerings comprising one or more service plans, each of the one or more service plans comprising service offers, wherein each of the service offers comprising service bundles defining one or more services as at least one of the prepaid and the postpaid;
b. creating an account of the customer and services corresponding to the one of the one or more service offerings into one or more layers in real time;
c. authorizing the services requested by the customer in real time;
d. rating the services as the at least one of the prepaid and the postpaid in real time; and
e. realizing one or more customer care functions as the at least one of the prepaid and the postpaid in real time.

20. The method according to claim 19, wherein the one or more layers comprise a Customer Relationship Management (CRM) layer, an integration layer, a rating and billing management layer, and a service activation platform layer.

21. The method according to claim 19 further comprising activating the services subscribed by the customer on a communication network.

22. The method according to claim 19 further comprising maintaining a billing profile for each of the service offers.

23. The method according to claim 19 further comprising:
a. creating a service instance corresponding to each of the service offers;
b. creating a balance group corresponding to each of the service instances; and
c. creating a billing profile corresponding to each of the service offers.
